(19) United States
(12) Patent Application Publication
(10) Pub. No.: US 2024/0145739 A1
(43) Pub. Date: May 2, 2024

(54) FUEL CELL VEHICLE AND METHOD OF COOLING THE SAME

(71) Applicants: HYUNDAI MOTOR COMPANY, Seoul (KR); KIA CORPORATION, Seoul (KR)

(72) Inventor: Hyeon Gi Shin, Yongin-si (KR)

(21) Appl. No.: 18/195,667

(22) Filed: May 10, 2023

(30) Foreign Application Priority Data
Oct. 31, 2022 (KR) 10-2022-0142249

(51) Int. Cl. H01M 8/04029; H01M 8/04119; H01M 8/04701; H01M 8/04746

(52) U.S. Cl. CPC H01M 8/04029; H01M 8/04156; H01M 8/04731; H01M 8/04768; H01M 2250/20

(57) ABSTRACT

A fuel cell vehicle includes a radiator, a fuel cell discharging product water as a result of generation of power, a first storage unit storing the product water as a first liquid, a second storage unit storing, as a second liquid, an additive liquid having a higher viscosity than the first liquid, a pump pumping a mixed liquid of the first liquid and the second liquid or the first liquid alone to the radiator, a first valve disposed between the first storage unit and the pump, a second valve disposed between the second storage unit and the pump, and a controller for determining, based on the temperature of the radiator, at least one of whether to cool the radiator or an extent to which the radiator is cooled and generating a pumping control signal and first and second valve control signals based on a result of determination.

### CROSS REFERENCE TO RELATED APPLICATIONS

This application claims the benefit of Korean Patent Application No. 10-2022-0142249, filed on Oct. 31, 2022, which is hereby incorporated by reference as if fully set forth herein.

### BACKGROUND

### Field

Embodiments relate to a fuel cell vehicle and a method of cooling the same.

### Discussion of the Related Art

In general, water may be generated in each of a plurality of unit cells of a fuel cell as a result of power generation using hydrogen and oxygen. This water may be used for various purposes. In particular, a large amount of water may be generated when a fuel cell is used in a large vehicle, such as a van or a truck, rather than a passenger car. As an example, this water may be used to cool a radiator of a fuel cell vehicle, but cooling efficiency is poor. Therefore, research with the goal of solving this problem is underway.

### SUMMARY

Accordingly, embodiments are directed to a fuel cell vehicle and a method of cooling the same that substantially obviate one or more problems due to limitations and disadvantages of the related art.

Embodiments provide a fuel cell vehicle having excellent cooling performance and a method of cooling the same.

However, the objects to be accomplished by the embodiments are not limited to the above-mentioned objects, and other objects not mentioned herein will be clearly understood by those skilled in the art from the following description.

A fuel cell vehicle according to an embodiment may include a radiator, a fuel cell configured to discharge product water as a result of generation of power, a first storage unit configured to store the product water as a first liquid, a second storage unit configured to store an additive liquid, which has a higher viscosity than the first liquid, as a second liquid, a pump configured to pump a mixed liquid of the first liquid and the second liquid or the first liquid alone to the radiator at a pressure corresponding to a pumping control signal, a first valve disposed between the first storage unit and the pump and configured to be opened or closed in response to a first valve control signal, a second valve disposed between the second storage unit and the pump and configured to be opened or closed in response to a second valve control signal, and a controller configured to determine, based on the temperature of the radiator, at least one of whether to cool the radiator or an extent to which the radiator is cooled and to generate the pumping control signal, the first valve control signal, and the second valve control signal based on a result of the determination.

In an example, the controller may generate at least one of the first valve control signal or the second valve control signal such that the mixed liquid pumped by the pump has a viscosity proportional to the temperature of the radiator.

In an example, the controller may generate the pumping control signal such that the pressure of the mixed liquid pumped by the pump is inversely proportional to the temperature of the radiator.

In an example, the controller may generate at least one of the first valve control signal or the second valve control signal such that, after the mixed liquid pumped by the pump is discharged to the radiator, the first liquid alone is discharged to the radiator.

In an example, the fuel cell vehicle may further include a condensed water generating unit configured to supply condensed water generated in the fuel cell vehicle to the first storage unit as the first liquid.

In an example, the second storage unit may include a first room storing the additive liquid as the second liquid, a second room storing coolant to cool the fuel cell or a battery, and a partition wall isolating the first room and the second room from each other.

In an example, the volume of the first room and the volume of the second room may be determined based on a change cycle of the coolant.

In an example, the additive liquid may include at least one of ethylene glycol or a surfactant.

In an example, the fuel cell vehicle may further include a spray unit configured to spray the mixed liquid pumped by the pump to the radiator in a mist form.

In an example, the fuel cell vehicle may further include a turbulence generator disposed between the pump and the spray unit to again mix the first liquid and the second liquid contained in the mixed liquid with each other.

In an example, the turbulence generator may include an inlet formed to allow the mixed liquid pumped by the pump to be introduced thereinto, an outlet formed to discharge the mixed liquid containing the first liquid and the second liquid mixed again with each other to the spray unit, and a body disposed between the inlet and the outlet and having a serpentine-type mixing flow path formed therein to allow the mixed liquid to flow therethrough.

In an example, a first time for which the mixed liquid is sprayed to the radiator may be shorter than a second time for which the first liquid is sprayed to the radiator.

According to another embodiment, a method of cooling a fuel cell vehicle including a fuel cell configured to discharge a first liquid containing product water generated as a result of generation of power and a radiator may include detecting the temperature of the radiator, generating a first mixed liquid by mixing an additive liquid, which is a second liquid having a higher viscosity than the first liquid, with the first liquid at a first ratio when the detected temperature falls within a first temperature range, generating a second mixed liquid by mixing the second liquid with the first liquid at a second ratio, which is lower than the first ratio, when the detected temperature falls within a second temperature range, which is lower than the first temperature range, and pumping the first mixed liquid or the second mixed liquid to the radiator.

In an example, a pressure at which the first mixed liquid is pumped may be lower than a pressure at which the second mixed liquid is pumped.

In an example, the method may further include pumping the first liquid to the radiator without mixing the second liquid with the first liquid when the detected temperature falls within a third temperature range, which is lower than the second temperature range.

In an example, a pressure at which the first liquid is pumped may be higher than a pressure at which the second mixed liquid is pumped.

### BRIEF DESCRIPTION OF THE FIGURES

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a circuit diagram of an embodiment of a condensed water generating unit shown in FIG. 1;

FIG. 3 is a conceptual diagram of an embodiment of a turbulence generator shown in FIG. 1; and

FIG. 4 is a flowchart for explaining a method of cooling a fuel cell vehicle according to an embodiment.

### DETAILED DESCRIPTION

The present disclosure will now be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a fuel cell vehicle according to an embodiment will be described with reference to the accompanying drawings.

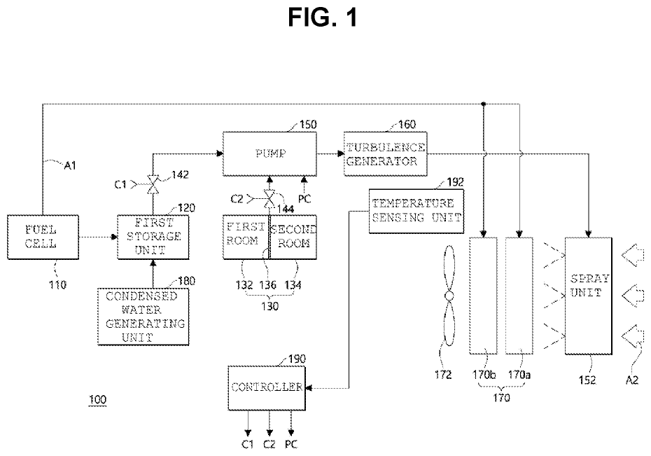

FIG. 1 is a block diagram of a fuel cell vehicle 100 according to an embodiment.

The fuel cell vehicle 100 shown in FIG. 1 may include a fuel cell 110, first and second storage units 120 and 130, first and second valves 142 and 144, a pump 150, a radiator 170, and a controller 190. In addition, the fuel cell vehicle 100 shown in FIG. 1 may further include a condensed water generating unit 180. In addition, the fuel cell vehicle 100 shown in FIG. 1 may further include a temperature sensing unit 192. In addition, the fuel cell vehicle 100 shown in FIG. 1 may further include a radiator fan 172. In addition, the fuel cell vehicle 100 shown in FIG. 1 may further include a spray unit 152.

The fuel cell 110 may be, for example, a polymer electrolyte membrane fuel cell (or a proton exchange membrane fuel cell) (PEMFC), which has been studied most extensively as a power source for driving vehicles. However, the embodiments are not limited to any specific form of the fuel cell 110.

As a result of power generation of the fuel cell 110, water (hereinafter referred to as product water) may be discharged therefrom. For example, the product water may have a temperature of 57° C. to 58° C., and may be discharged at the rate of 0.6 liters per minute.

In the fuel cell 110, hydrogen, which is a fuel, may be supplied to a fuel electrode through a first separator (not shown), and air containing oxygen, which is an oxidizer, may be supplied to an air electrode through a second separator (not shown).

The hydrogen supplied to the fuel electrode is decomposed into hydrogen ions (protons) (H+) and electrons (e−) by a catalyst. The hydrogen ions alone may be selectively transferred to the air electrode through a polymer electrolyte membrane, and at the same time, the electrons may be transferred to the air electrode through gas diffusion layers, which are conductors, and the separators. In order to realize the above operation, a catalyst layer may be applied to each of the fuel electrode and the air electrode. The movement of the electrons described above causes the electrons to flow through an external conductive wire, thus generating current. That is, the fuel cell 110 may generate electric power due to electrochemical reaction between hydrogen, which is a fuel, and oxygen contained in air.

In the air electrode, the hydrogen ions supplied thereto through the polymer electrolyte membrane and the electrons transferred thereto through the separators meet oxygen contained in the air supplied thereto, thereby causing a reaction that generates product water.

The radiator fan 172 may be configured to control the speed of a motor for rotating an impeller, which draws air toward the radiator fan 172, in order to control the flow of air toward the radiator 170 and/or the flow of air from the radiator 170. The radiator 170 may be a type of heat sink, and may include a main radiator 170a and a sub-radiator 170b.

The embodiments are not limited as to the type of radiator 170, the number of radiators 170, the presence or absence of the radiator fan 172, or the specific form of the radiator fan 172.

The first storage unit 120 serves to store, as a first liquid, product water discharged from the fuel cell 110. In addition, the first storage unit 120 may store, as the first liquid, condensed water generated in the condensed water generating unit 180 as well as the product water. For example, the condensed water may have a temperature of 20° C. to 25° C., and may be discharged at the rate of 0.5 liters per minute.

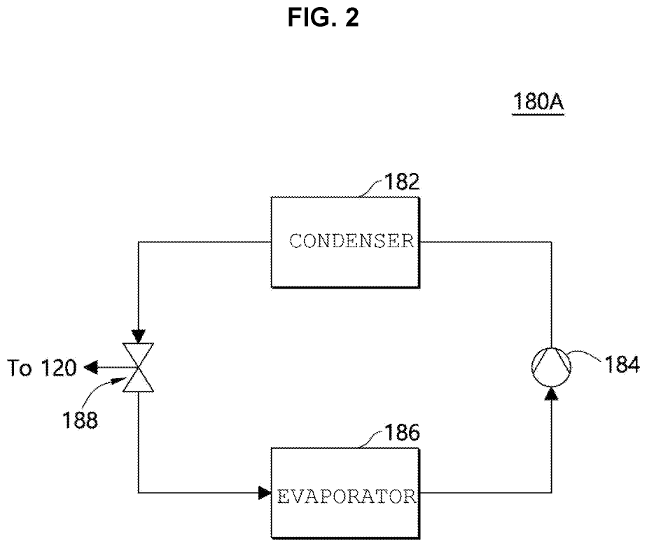

FIG. 2 is a circuit diagram of an embodiment 180A of the condensed water generating unit 180 shown in FIG. 1.

The condensed water generating unit 180A shown in FIG. 2 may include a condenser 182, a compressor 184, an evaporator 186, and a three-way valve 188.

The evaporator 186 shown in FIG. 2 may include a plurality of tubes (not shown) allowing flow of a refrigerant. Heat may be transferred to water in the condenser 182. The condensed water may be supplied from the three-way valve 188 to the first storage unit 120.

Referring back to FIG. 1, the second storage unit 130 may store, as a second liquid, an additive liquid having a higher viscosity than the product water, which is the first liquid. In an example, according to the embodiment, the second storage unit 130 may include a first room 132, a second room 134, and a partition wall 136.

The first room 132 may be defined as a space storing the additive liquid, and the second room 134 may be defined as a space storing a coolant for cooling the fuel cell 110 or a battery (not shown). In this case, the partition wall 136 may serve to isolate the first room 132 and the second room 134 from each other.

In this case, according to the embodiment, the volume (or the capacity) of the first room 132 and the volume (or the capacity) of the second room 134 may be determined based on the change cycle of the coolant. For example, when the change cycle of the coolant stored in the second room 134 in order to cool the battery or the fuel cell 110 is 60,000 km, the volume of the first room 132 may be determined such that the change cycle of the additive liquid stored in the first room 132 becomes 60,000 km.

If the first room 132 and the second room 134 are provided separately as individual storage tanks, the space occupied by the storage tanks in the fuel cell vehicle may increase. In order to prevent this problem, in the fuel cell vehicle according to the embodiment, the first room 132 and the second room 134 are formed in a single integral-type tank so as to be isolated from each other by the partition wall 136, and the integral-type tank is located in a single space. Accordingly, the efficiency of use of space may increase. The second liquid stored in the first room 132 and the coolant stored in the second room 134 may have the same component as each other, for example a mixture of water and ethylene glycol. Therefore, the first room 132 and the second room 134 may be integrally included in the second storage unit 130, which is made of a specific material (e.g. a plastic material).

In addition, the additive liquid stored as the second liquid in the second room 134 may be selected from among materials that are capable of increasing in viscosity when mixed with the first liquid, of preventing corrosion of the radiator 170 even when remaining on the radiator 170 for a certain time period, and of being easily washed out by the first liquid. For example, the additive liquid, which is the second liquid, may include at least one of ethylene glycol or a surfactant. As an example, the second liquid may include ethylene glycol and a surfactant. For example, at a temperature of 20° C., the viscosity of water is 1 cP, and the viscosity of ethylene glycol is 16.1 cP, which is higher than the viscosity of water. Therefore, the viscosity of a mixed liquid of the first liquid and the second liquid may be higher than that of water.

The first liquid stored in the first storage unit 120, i.e. at least one of product water or condensed water, may be supplied to the pump 150 through the first valve 142.

The second liquid stored in the second storage unit 130, i.e. the additive liquid, may be supplied to the pump 150 through the second valve 144. In addition, the coolant stored in the second storage unit 130 may be supplied to the fuel cell 110. Although a specific route along which the coolant stored in the second storage unit 130 is supplied to the fuel cell 110 is not shown in FIG. 1, this is well known in the art, and thus a detailed description thereof will be omitted.

The pump 150 may pump a liquid at a pressure corresponding to a pumping control signal PC, and may supply the liquid to the radiator 170. That is, the pump 150 may control the flow rate of a fluid supplied to the radiator 170 in response to the pumping control signal PC.

In order to increase the pressure at which the pump 150 pumps a liquid, it is necessary to increase the number of revolutions per minute (RPM) of the pump 150. In order to reduce the pressure at which the pump 150 pumps a liquid, it is necessary to reduce the RPM of the pump 150. The RPM of the pump 150 may be determined based on the pumping control signal PC.

The first valve 142 may be disposed between the first storage unit 120 and the pump 150, and may be opened or closed in response to a first valve control signal C1. The first liquid stored in the first storage unit 120 may be supplied to the pump 150 for a time for which the first valve 142 is open in response to the first valve control signal C1.

The second valve 144 may be disposed between the second storage unit 130 and the pump 150, and may be opened or closed in response to a second valve control signal C2. The second liquid stored in the second storage unit 130 may be supplied to the pump 150 for a time for which the second valve 144 is open in response to the second valve control signal C2.

The longer the time for which the first valve 142 is open, the greater the amount of first liquid supplied to the pump 150. The longer the time for which the second valve 144 is open, the greater the amount of second liquid supplied to the pump 150. Therefore, the component of the mixed liquid (i.e. the content of the second liquid) pumped by the pump 150 may be determined by adjusting the time for which at least one of the first valve 142 or the second valve 144 is open. That is, the controller 190 may open or close the first and second valves 142 and 144 in an electronical manner using the first and second valve control signals C1 and C2 to adjust the mixing ratio between the first liquid and the second liquid, thereby generating a mixed liquid having the adjusted mixing ratio.

The controller 190 may determine, based on the temperature of the radiator 170, at least one of whether to cool the radiator 170 or the extent to which the radiator 170 is cooled, and may generate the pumping control signal PC, the first valve control signal C1, and the second valve control signal C2 based on a result of determination. To this end, the temperature sensing unit 192 may detect the temperature of the entrance of the radiator 170, and may provide the detected temperature to the controller 190 as the temperature of the radiator 170.

According to the embodiment, the controller 190 may generate at least one of the first valve control signal C1 or the second valve control signal C2 such that a mixed liquid of the additive liquid, which is the second liquid pumped by the pump 150, and the product water, which is the first liquid, has a viscosity proportional to the temperature of the radiator 170.

That is, as the temperature of the radiator 170 is increased, the amount of additive liquid (i.e. the second liquid) that is added to the first liquid is increased such that the viscosity of the mixed liquid pumped by the pump 150 is increased. To this end, the controller 190 generates the first and second valve control signals C1 and C2 to control the first and second valves 142 and 144 such that a larger amount of second liquid, which has a higher viscosity than the first liquid, is supplied to the pump 150 by increasing the time for which the second valve 144 is open.

Alternatively, as the temperature of the radiator 170 is lowered, the amount of second liquid that is added to the first liquid is reduced such that the viscosity of the mixed liquid pumped by the pump 150 is reduced. To this end, the controller 190 generates the second valve control signal C2 to control the second valve 144 such that a smaller amount of second liquid, which has a higher viscosity than the first liquid, is supplied to the pump 150 or such that the second liquid is not supplied to the pump 150 by reducing the time for which the second valve 144 is open.

As the viscosity of the mixed liquid pumped by the pump 150 is increased, the mixed liquid sticks to the radiator 170 for a longer time period after being sprayed to the radiator 170, and accordingly, cooling performance may be further improved. Therefore, according to the embodiment, it is possible to maximize the cooling efficiency of the radiator 170 by adjusting the viscosity of the mixed liquid discharged to the radiator 170 based on the temperature of the radiator 170.

According to the embodiment, the controller 190 may generate at least one of the first valve control signal C1 or the second valve control signal C2 such that only the first liquid is discharged to the radiator 170 after the mixed liquid pumped by the pump 150 is discharged to the radiator 170.

As described above, when the temperature of the radiator 170 is high, the second liquid containing the additive liquid is discharged to the radiator 170 in order to cool the radiator 170. In this case, however, the radiator 170 may be contaminated. Therefore, in order to prevent this problem, after the mixed liquid containing the additive liquid is discharged to the radiator 170, the first liquid not containing the additive liquid, i.e. the product water, may be discharged to the radiator 170 in order to wash out the additive liquid remaining on the radiator 170.

According to the embodiment, the controller 190 generates the pumping control signal PC such that the pressure of the liquid (the mixed liquid or the first liquid) pumped by the pump 150 is inversely proportional to the temperature of the radiator 170.

That is, the controller 190 may generate the pumping control signal PC such that the pressure of the liquid pumped by the pump 150 is reduced (i.e. the RPM of the pump 150 is reduced) as the temperature of the radiator 170 is increased.

Alternatively, the controller 190 may generate the pumping control signal PC such that the pressure of the liquid pumped by the pump 150 is increased (i.e. the RPM of the pump 150 is increased) as the temperature of the radiator 170 is lowered.

As the pressure of the mixed liquid pumped by the pump 150 is reduced, the mixed liquid discharged to the radiator 170 sticks to the radiator 170 for a longer time period, and absorbs a larger amount of heat from the radiator 170 to cool the same. Accordingly, cooling efficiency may be further improved. In addition, the pressure of the first liquid pumped by the pump 150 may be increased so that the first liquid is discharged to the radiator 170 at a high pressure to wash the radiator 170.

As described above, when the mixed liquid is sprayed to the radiator 170, the pressure of the mixed liquid pumped by the pump 150 is reduced so that the mixed liquid is sprayed to the radiator 170 at a low pressure for the purpose of cooling the radiator 170. On the other hand, when only the first liquid is sprayed to the radiator 170, the pressure of the first liquid pumped by the pump 150 is increased so that the first liquid is sprayed to the radiator 170 at a high pressure for the purpose of washing and additionally cooling the radiator 170, rather than for the purpose of cooling the radiator 170. For example, the pressure of the first liquid sprayed for washing may be set to a level that does not affect the durability of the radiator 170.

Therefore, according to an embodiment, it is possible to maximize the cooling efficiency of the radiator 170 and to more effectively wash the radiator 170 by adjusting the pressure of the liquid pumped by the pump 150 based on the temperature of the radiator 170.

The spray unit 152 serves to spray the mixed liquid pumped by the pump 150 to the radiator 170 in a mist form. Accordingly, the mixed liquid may be evenly sprayed over the fins of the radiator 170 through the nozzle (not shown) of the spray unit 152. In addition, when a surfactant, which is the second liquid, is mixed with the first liquid, the mixed liquid is sprayed in a mist form, and thus sticks more strongly to the fins of the radiator 170, thereby increasing cooling performance.

As the pressure of the liquid pumped by the pump 150 becomes higher (or increases), the liquid may be sprayed to the radiator 170 at a higher pressure from the spray unit 152. As the pressure of the liquid pumped by the pump 150 becomes lower (or decreases), the liquid may be sprayed to the radiator 170 at a lower pressure from the spray unit 152.

In addition, a first time for which the mixed liquid containing the second liquid is sprayed to the radiator 170 may be shorter than a second time for which the first liquid not containing the additive liquid is sprayed to the radiator 170. The reason for this is to additionally cool the radiator 170 while sufficiently washing out the second liquid sticking to the radiator 170 using the first liquid.

In addition, after the mixed liquid containing the additive liquid is sprayed to the radiator 170 a predetermined number of times, the radiator 170 may be washed by the first liquid. That is, according to the embodiment, it is possible to periodically wash the radiator 170 using the first liquid after spraying the mixed liquid to the radiator 170 a predetermined number of times.

In addition, the fuel cell vehicle 100 according to the embodiment may further include a turbulence generator 160. The turbulence generator 160 is disposed between the pump 150 and the spray unit 152 in order to again mix the second liquid and the first liquid with each other. Since the two different liquids, i.e. the first liquid and the second liquid, mix with each other again in the turbulence generator 160, the second liquid contained in the mixed liquid may be evenly sprayed to the radiator 170.

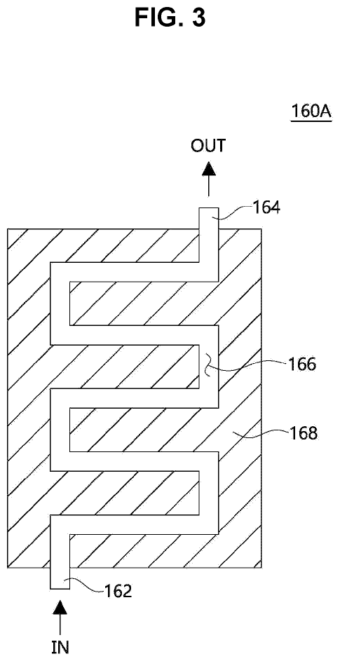

FIG. 3 is a conceptual diagram of an embodiment 160A of the turbulence generator 160 shown in FIG. 1.

The turbulence generator 160A shown in FIG. 3 may include an inlet 162, an outlet 164, and a body 168.

The inlet 162 is a portion through which the liquid pumped by the pump 150 flows into the turbulence generator 160A in a direction indicated by the arrow IN, and the outlet 164 is a portion through which the liquid flows out of the turbulence generator 160A toward the spray unit 152 in a direction indicated by the arrow OUT. The body 168 may include a mixing flow path 166, which is disposed between the inlet 162 and the outlet 164 to form a route along which the liquid flows and has a serpentine shape.

When the turbulence generator 160A is implemented as a turbulator configured as shown in FIG. 3, the first liquid and the second liquid, which have mutually different viscosities, may mix with each other again while flowing through the mixing flow path 166.

If the mixed liquid is introduced into the inlet IN of the turbulence generator 160A in the state in which the first liquid and the second liquid contained therein are not sufficiently mixed with each other, the first liquid and the second liquid may sufficiently mix with each other while flowing through the mixing flow path 166, and may then be discharged through the outlet 164.

Referring back to FIG. 1, the coolant may be supplied to the radiator 170 in a direction indicated by the arrow A1 after cooling the fuel cell 110. For example, the temperature of the coolant supplied to the radiator 170 in a direction indicated by the arrow A1 may be 75° C. to 80° C.

Hereinafter, a method of cooling the fuel cell vehicle 100 according to an embodiment will be described with reference to the accompanying drawings.

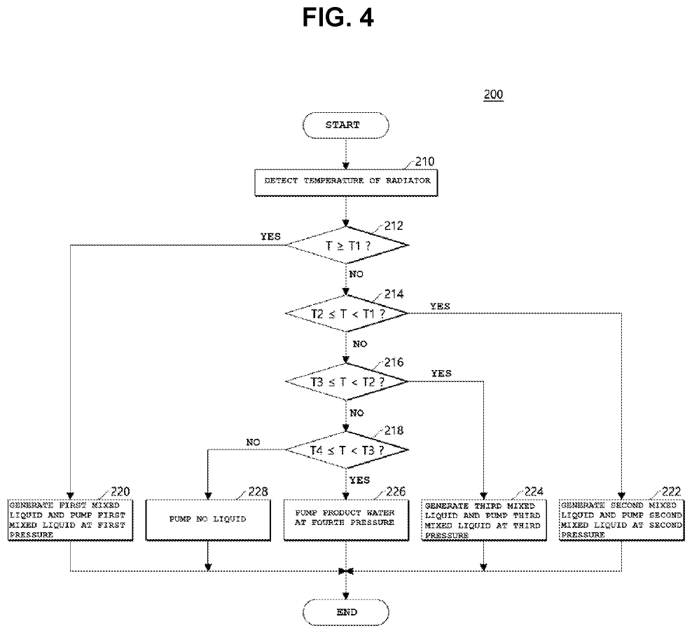

FIG. 4 is a flowchart for explaining a method 200 of cooling the fuel cell vehicle according to an embodiment.

According to the method 200 of cooling the fuel cell vehicle according to the embodiment, the temperature of the radiator 170 is detected at 210. Step 210 may be performed by the temperature sensing unit 192, and the detected temperature may be a temperature of the entrance of the radiator 170.

After step 210, a temperature range within which the detected temperature T falls is determined at 212 to 218. A mixed liquid of the first liquid and the second liquid is pumped by varying a mixing ratio of the second liquid, which is the additive liquid, to the first liquid depending on the temperature range within which the detected temperature falls at 220 to 224.

When the detected temperature falls within a first temperature range, the additive liquid, which is the second liquid having a higher viscosity than the product water, which is the first liquid, is mixed with the first liquid at a first ratio to generate a mixed liquid. When the detected temperature falls within a second temperature range, which is lower than the first temperature range, the second liquid is mixed with the first liquid at a second ratio, which is lower than the first ratio, to generate a mixed liquid. Thereafter, the mixed liquid is pumped to the radiator 170. When the detected temperature falls within a third temperature range, which is lower than the second temperature range, the second liquid is not mixed with the first liquid, and the first liquid alone is pumped to the radiator 170.

For example, referring to FIG. 4, a determination is made as to whether the detected temperature T falls within a temperature range higher than or equal to a first predetermined temperature T1 at 212. If the detected temperature T is lower than the first predetermined temperature T1, a determination is made as to whether the detected temperature T falls within a temperature range lower than the first predetermined temperature T1 but higher than or equal to a second predetermined temperature T2 at 214. If the detected temperature T does not fall within the temperature range lower than the first predetermined temperature T1 but higher than or equal to the second predetermined temperature T2, a determination is made as to whether the detected temperature T falls within a temperature range lower than the second predetermined temperature T2 but higher than or equal to a third predetermined temperature T3 at 216. If the detected temperature T does not fall within the temperature range lower than the second predetermined temperature T2 but higher than or equal to the third predetermined temperature T3, a determination is made as to whether the detected temperature T falls within a temperature range lower than the third predetermined temperature T3 but higher than or equal to a fourth predetermined temperature T4 at 218.

The first to fourth predetermined temperatures T1, T2, T3, and T4 shown in FIG. 4 have the relationships shown in Equation 1 below.

T1>T2>T3>T4 Equation 1:

According to an embodiment, the first predetermined temperature T1, the second predetermined temperature T2, the third predetermined temperature T3, and the fourth predetermined temperature T4 may be 80° C., 75° C., 70° C., and 60° C., respectively, but the embodiments are not limited thereto.

When the detected temperature T falls within the temperature range greater than or equal to the first predetermined temperature T1, the second liquid is mixed with the first liquid at a first ratio to generate a first mixed liquid at 220. When the detected temperature T falls within the temperature range lower than the first predetermined temperature T1 but greater than or equal to the second predetermined temperature T2, the second liquid is mixed with the first liquid at a second ratio, which is lower than the first ratio, to generate a second mixed liquid at 222. When the detected temperature T falls within the temperature range lower than the second predetermined temperature T2 but greater than or equal to the third predetermined temperature T3, the second liquid is mixed with the first liquid at a third ratio, which is lower than the second ratio, to generate a third mixed liquid at 224. For example, the first ratio of the second liquid to the first liquid may be 2.5:7.5, the second ratio of the second liquid to the first liquid may be 2:8, and the third ratio of the second liquid to the first liquid may be 1.5:8.5. However, the embodiments are not limited thereto.

After the first, second, or third mixed liquid is generated in steps 220 to 224, the first, second, or third mixed liquid is pumped to be sprayed to the radiator 170. In this case, the first mixed liquid, the second mixed liquid, and the third mixed liquid are pumped at a first pressure, a second pressure, and a third pressure, respectively.

When the detected temperature T falls within the temperature range lower than the third predetermined temperature T3 but higher than or equal to the fourth predetermined temperature T4, the second liquid is not mixed with the first liquid, and the first liquid alone is pumped at a fourth pressure to be sprayed through the spray unit 152, thereby additionally cooling the radiator 170 and, at the same time, washing the radiator 170 to keep the same clean at 226.

In addition, according to the embodiment, the greater the amount of second liquid mixed with the first liquid, the lower the pressure at which the mixed liquid is pumped. That is, according to the embodiment, the first to fourth pressures have the relationships shown in Equation 2 below.

first pressure<second pressure<third pressure<fourth pressure Equation 2

It can be seen from Equation 2 that the fourth pressure at which the first liquid is pumped is higher than the third pressure at which the third mixed liquid is pumped. The reason for this is to effectively wash the radiator 170 using the first liquid.

When the detected temperature T does not fall within the temperature range lower than the third predetermined temperature T3 but higher than or equal to the fourth predetermined temperature T4, that is, when the detected temperature T is lower than the fourth predetermined temperature T4, it is determined that the radiator 170 has been sufficiently cooled or that the radiator 170 may be supercooled, and the liquid is not pumped at 228. In this case, the radiator 170 may be cooled by external air introduced from the outside of the fuel cell vehicle in a direction indicated by the arrow A2 shown in FIG. 1. The temperature of the external air A2 may be 35° C. to 40° C.

According to the embodiment, a third temperature difference ΔT3 between the third predetermined temperature T3 and the fourth predetermined temperature T4 may be greater than or equal to a predetermined value (e.g. 10). The predetermined value may be greater than each of a first temperature difference ΔT1 between the first predetermined temperature T1 and the second predetermined temperature T2 and a second temperature difference ΔT2 between the second predetermined temperature T2 and the third predetermined temperature T3.

The reason why the third temperature difference ΔT3 is determined as described above is that the mixed liquid is first sprayed to the radiator 170 and then the first liquid is sprayed to the radiator 170 to wash the same. In addition, the reason for this is to prevent the radiator 170 from being excessively cooled by spraying only the first liquid to the radiator 170 when the detected temperature T decreases below the third predetermined temperature T3. For example, when the third temperature difference ΔT3 is set to be less than the predetermined value, the radiator 170 may be sufficiently cooled, but may not be properly washed.

When the fuel cell vehicle is cooled using the radiator, if only the first liquid, which is pure water, is sprayed to the radiator, most of the water falls below the radiator 170, thus causing deterioration in evaporative cooling performance. Therefore, according to the embodiment, a mixed liquid, which is generated by mixing the second liquid, which is a mixture of ethylene glycol and a surfactant, with the first liquid, which is pure water, so as to have a higher viscosity than water, is sprayed to the radiator 170. Since the mixed liquid has a higher viscosity than pure water, the mixed liquid sticks to the radiator 170 relatively strongly, thereby improving cooling performance using heat of vaporization of water.

In addition, due to the characteristics of an engine of the fuel cell vehicle, even if a fire in the engine compartment of the vehicle is extinguished in an early stage of the fire, there is a high probability of re-ignition due to heat remaining in the engine. Thus, a fire-extinguishing liquid having excellent fire-extinguishing power is required. Even if a fire in the engine compartment is extinguished in an early stage of the fire using pure water, the risk of re-ignition increases if the water remaining in the fire occurrence area is exhausted later.

In consideration thereof, a mixed liquid generated by mixing ethylene glycol and an alkyl polyglucoside (APG) surfactant with pure water may be used to extinguish a fire in the engine compartment of the fuel cell vehicle. This mixed liquid may exhibit improved fire-extinguishing effect compared to pure water.

The fuel cell vehicle and the method of cooling the same according to the above-described embodiments may be applied to aircraft, ships, stationary power generation systems, and the like, without being limited thereto.

As is apparent from the above description, according to the fuel cell vehicle and the method of cooling the same according to the embodiments, as the temperature of the radiator is increased, the viscosity of the mixed liquid pumped by the pump may be increased so that the mixed liquid sprayed to the radiator sticks to the radiator for a longer time period, whereby cooling performance may be further improved. After the mixed liquid is discharged to the radiator, the first liquid, which is product water, may be discharged to the radiator to wash out the additive liquid remaining on the radiator. Since the mixed liquid pumped by the pump is sprayed to the radiator in a mist form through the spray unit, the mixed liquid may be evenly sprayed over the fins of the radiator and may stick more strongly thereto, thereby increasing cooling performance. Since the second liquid and the first liquid mix with each other again in the turbulence generator, the second liquid contained in the mixed liquid may be evenly sprayed to the radiator. Since the first room storing the second liquid and the second room storing the coolant are formed in a single integral-type tank so as to be isolated from each other by a partition wall and the integral-type tank is located in a single space, the efficiency of use of space may increase.

However, the effects achievable through the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims

1. A fuel cell vehicle having a radiator, the fuel cell vehicle comprising:
a fuel cell configured to discharge product water as a result of generation of power;
a first storage unit configured to store the product water as a first liquid;
a second storage unit configured to store an additive liquid as a second liquid, the additive liquid having a higher viscosity than the first liquid;
a pump configured to pump a mixed liquid of the first liquid and the second liquid or the first liquid alone to the radiator at a pressure corresponding to a pumping control signal;
a first valve disposed between the first storage unit and the pump, the first valve being opened or closed in response to a first valve control signal;
a second valve disposed between the second storage unit and the pump, the second valve being opened or closed in response to a second valve control signal; and
a controller configured to determine, based on a temperature of the radiator, at least one of whether to cool the radiator or an extent to which the radiator is cooled, and to generate the pumping control signal, the first valve control signal, and the second valve control signal based on a result of the determination.

2. The fuel cell vehicle according to claim 1, wherein the controller generates at least one of the first valve control signal or the second valve control signal so that the mixed liquid pumped by the pump has a viscosity proportional to a temperature of the radiator.

3. The fuel cell vehicle according to claim 1, wherein the controller generates the pumping control signal so that a pressure of the mixed liquid pumped by the pump is inversely proportional to a temperature of the radiator.

4. The fuel cell vehicle according to claim 1, wherein the controller generates at least one of the first valve control signal or the second valve control signal so that, after the mixed liquid pumped by the pump is discharged to the radiator, the first liquid alone is discharged to the radiator.

5. The fuel cell vehicle according to claim 1, further comprising:
a condensed water generating unit configured to supply condensed water generated in the fuel cell vehicle to the first storage unit as the first liquid.

6. The fuel cell vehicle according to claim 1, wherein the second storage unit comprises:
a first room configured to store the additive liquid as the second liquid;
a second room configured to store coolant to cool the fuel cell or a battery; and
a partition wall separating the first room and the second room.

7. The fuel cell vehicle according to claim 6, wherein a volume of the first room and a volume of the second room are determined based on a change cycle of the coolant.

8. The fuel cell vehicle according to claim 1, wherein the additive liquid comprises at least one of ethylene glycol or a surfactant.

9. The fuel cell vehicle according to claim 1, further comprising:
a spray unit configured to spray the mixed liquid pumped by the pump to the radiator in a mist form.

10. The fuel cell vehicle according to claim 9, further comprising:
a turbulence generator disposed between the pump and the spray unit to again mix the first liquid and the second liquid contained in the mixed liquid with each other.

11. The fuel cell vehicle according to claim 10, wherein the turbulence generator comprises:
an inlet configured to receive the mixed liquid pumped by the pump;
an outlet configured to discharge the mixed liquid containing the first liquid and the second liquid mixed again with each other to the spray unit; and
a body disposed between the inlet and the outlet, the body having a serpentine shaped mixing flow path formed therein to allow the mixed liquid to flow therethrough.

12. The fuel cell vehicle according to claim 9, wherein a first time for which the mixed liquid is sprayed to the radiator is shorter than a second time for which the first liquid is sprayed to the radiator.

13. A method of cooling a fuel cell vehicle comprising a fuel cell configured to discharge a first liquid containing product water generated as a result of generation of power and a radiator, the method comprising:
detecting a temperature of the radiator;
generating a first mixed liquid by mixing an additive liquid with the first liquid at a first ratio when the detected temperature of the radiator falls within a first temperature range, the additive liquid being a second liquid having a higher viscosity than the first liquid;
generating a second mixed liquid by mixing the second liquid with the first liquid at a second ratio when the detected temperature of the radiator falls within a second temperature range, the second ratio being lower than the first ratio, the second temperature range being lower than the first temperature range; and
pumping the first mixed liquid or the second mixed liquid to the radiator.

14. The method according to claim 13, wherein a pressure at which the first mixed liquid is pumped is lower than a pressure at which the second mixed liquid is pumped.

15. The method according to claim 13, further comprising:
pumping the first liquid to the radiator without mixing the second liquid with the first liquid when the detected temperature of the radiator falls within a third temperature range, the third temperature range being lower than the second temperature range.

16. The method according to claim 15, wherein a pressure at which the first liquid is pumped is higher than a pressure at which the second mixed liquid is pumped.
